(19) United States
(12) Patent Application Publication
(10) Pub. No.: US 2009/0242846 A1
(43) Pub. Date: Oct. 1, 2009

(54) TRANSPARENT ELECTRIC CONDUCTOR

(75) Inventors: Noriyuki YASUDA, Tokyo (JP); Masutatsu MASHIMO, Tokyo (JP); Kazuhisa INABA, Tokyo (JP); Mitsuhiro KAWANISHI, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/356,966

(22) Filed: Jan. 21, 2009

(30) Foreign Application Priority Data
Mar. 28, 2008 (JP) P2008-086565

(51) Int. Cl. H01B 1/12

(52) U.S. Cl. 252/500

(57) ABSTRACT

There is provided a transparent electric conductor with reduced variation in electrical resistance in high-temperature environments. The transparent electric conductor comprises conductive particles 11 and a binder 12. The binder 12 includes at least one additive selected from among compounds represented by the following general formula (1), (2) or (3).

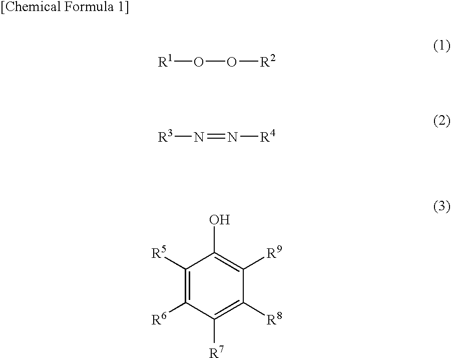

### BACKGROUND OF THE INVENTION

1. Field of the Invention

The present invention relates to a transparent electric conductor.

2. Related Background Art

Transparent electric conductors comprising conductive particles dispersed in a binder are known for use as transparent electric conductors in touch panels and the like (for example, see Japanese Patent Application Laid-Open No. 2007-66711). It is particularly important for transparent electric conductor films having a transparent conductive layer formed on one or both sides (transparent conductive films), to exhibit no variation in electrical resistance in the environments in which they are used. Methods for controlling the variation in electrical resistance in high-humidity environments have been disclosed and involve surface treatment of conductive powder to impart it with water resistance (See Japanese Patent Application Laid-Open No. 2006-059722).

### SUMMARY OF THE INVENTION

Conventional transparent conductive films having conductive particles dispersed in a binder, however, exhibit large variation in electrical resistance after storage in high-temperature environments, and in this respect they are in need of further improvement. Because transparent conductive films are in most cases exposed to high-temperature environments, it is very important in practical use to minimize such variation in electrical resistance after storage in high-temperature environments.

It is therefore an object of the present invention to provide a transparent electric conductor with reduced variation in electrical resistance before and after exposure to high-temperature environments.

As a result of much diligent research directed towards solving the aforementioned problems, the present inventors have completed this invention upon finding that variation in electrical resistance in high-temperature environments can be reduced by adding specific compounds to the binder.

Specifically, the invention relates to a transparent electric conductor comprising a transparent conductive layer containing conductive particles and a binder, wherein the binder includes at least one additive selected from among compounds represented by the following general formula (1), (2) or (3).

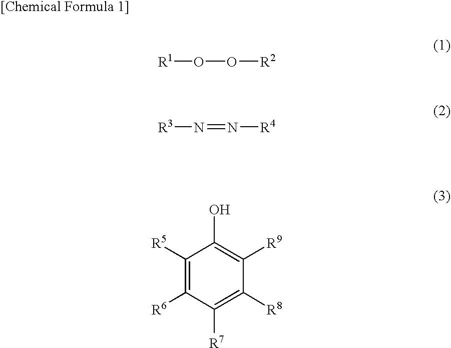

In formula (1), R¹ and R² each independently represent hydrogen or a monovalent organic group, in formula (2), R³ and R⁴ each independently represent a monovalent organic group, and in formula (3), R⁵, R⁶, R⁷, R⁸ and R⁹ each independently represent hydrogen, methyl, butyl, hydroxyl or methoxy.

Including such additives reduces the variation in electrical resistance of the transparent electric conductor of the invention in high-temperature environments. While the reason for this effect is not fully understood, it is believed possible that the additives or free radicals produced by their decomposition react with oxygen in high-temperature environments, thereby reducing oxidative degradation of the binder or conductive particles and resulting in reduced variation in electrical resistance.

The additive content is preferably no greater than 3 wt % based on the weight of the binder. If the content is greater than 3 wt % the effect of reduced variation in electrical resistance will tend to be less notable, and the transparent electric conductor may also exhibit yellowing.

The decomposition temperature of the additive is preferably 60° C. or higher. If an additive with a decomposition temperature of below 60° C. is used, the additive will gradually decompose even at ordinary temperature, potentially having an adverse effect on the function of the transparent electric conductor. By using an additive with a decomposition temperature of 60° C. or higher, it is possible to optimally reduce electrical resistance variation in high-temperature environments while maintaining satisfactory stability at ordinary temperature. The decomposition temperature of the additive referred to here is the lowest temperature in the temperature range at which the effect of the additive increases by decomposition or cleavage of the additive molecules.

According to the invention there is provided a transparent electric conductor with reduced variation in electrical resistance in high-temperature environments.

### BRIEF DESCRIPTION OF THE DRAWINGS

FIG. 1 is a cross-sectional view showing an embodiment of a transparent electric conductor.

### DESCRIPTION OF THE PREFERRED EMBODIMENTS

A preferred embodiment of the invention the invention will now be explained in detail, with reference to the accompanying drawings as necessary. However, the present invention is not limited to the embodiment described below. Also, the dimensional proportions depicted in the drawings are not necessarily limitative.

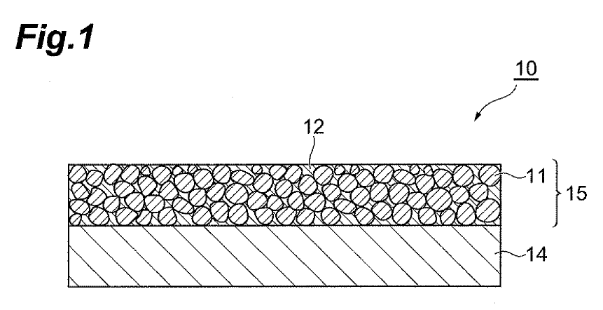

FIG. 1 is a cross-sectional view showing an embodiment of a transparent electric conductor. The transparent electric conductor film 10 shown in FIG. 1 comprises a substrate 14, and a transparent conductive layer 15 formed on the substrate 14. The transparent conductive layer 15 is composed of conductive particles 11 and a binder 12. The conductive particles 11 are dispersed in the binder 12. The binder 12 contains a resin as the main component, and further contains one or more additives selected from the group consisting of peroxides represented by the following general formula (1), azo compounds represented by the following general formula (2) and phenol compounds represented by the following general formula (3).

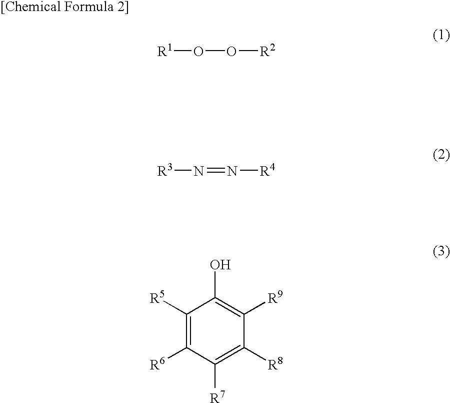

In general formula (1), R¹ and R² each independently represent hydrogen or monovalent organic groups. The monovalent organic group as R¹ or ² is a group containing C and H, and optionally also containing O. R¹ and R² are preferably hydrogen, alkyl, aryl or arylcarbonyl.

In general formula (2), R³ and R⁴ each independently represent monovalent organic groups. The monovalent organic group as R³ or R⁴ is also a group containing C and H, and optionally also containing either or both O and N. R³ and R⁴ are preferably optionally substituted branched alkyl groups or optionally substituted cycloalkyl groups.

In formula (3), R⁵, R⁶, R⁷, R⁸ and R⁹ each independently represent hydrogen, methyl, butyl, hydroxyl or methoxy.

The decomposition temperature of the additive is preferably 60° C. or higher. If the decomposition temperature is below 60° C., the shelf life of the transparent electric conductor at ordinary temperature will tend to be shortened. Since the peroxides of formula (1) and the azo compounds of formula (2) exhibit their functions upon cleavage or decomposition, their decomposition temperatures are especially preferred to be 60° C. or higher. The decomposition temperatures of these peroxides and azo compounds may be considered to be the temperatures at which they have a 10 hour half-life. There are no particular restrictions on the decomposition temperatures of the phenol compounds of formula (3), whose functions depend on the molecular structure.

As specific examples of preferred additives there may be mentioned compounds represented by the following formulas (1a)-(1d), (2a)-(2d) and (3a)-(3g). In formula (2d), x represents a natural number of 1-100 and n represents a natural number of 2-50.

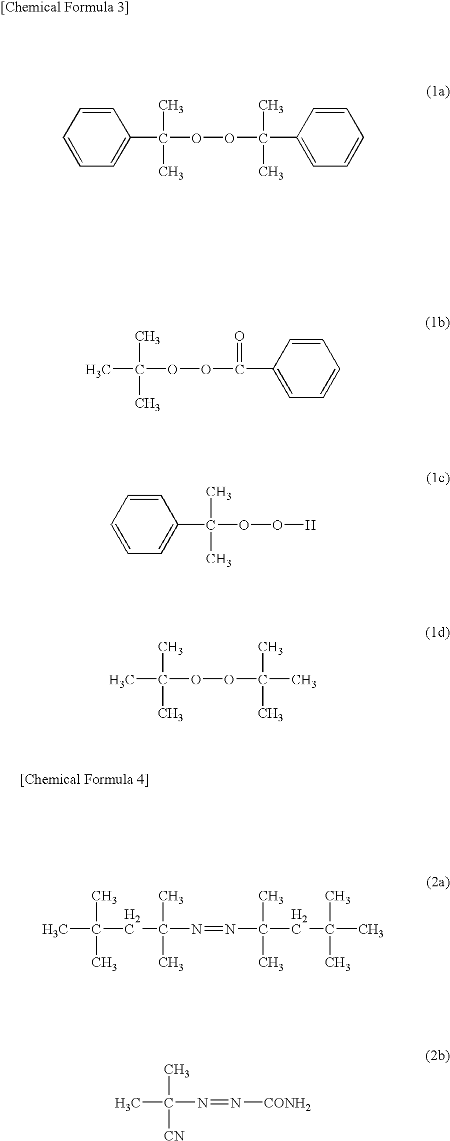

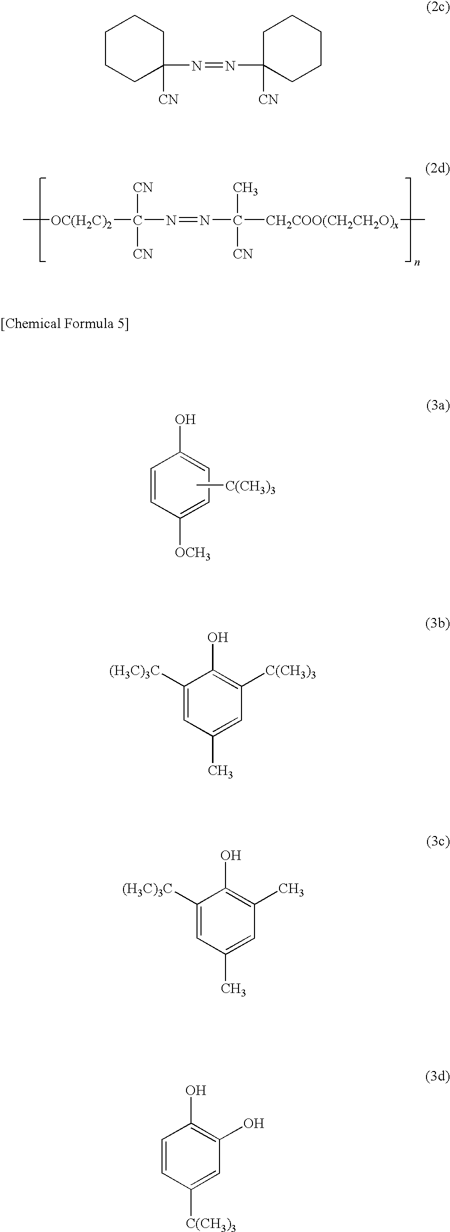

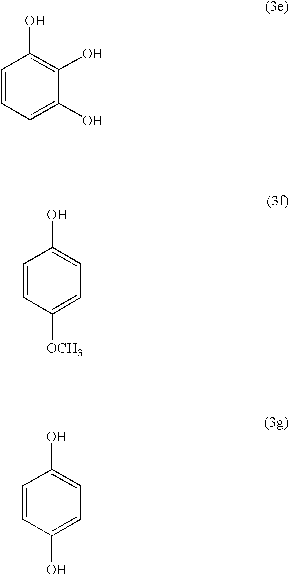

The content of additives is preferably no greater than 3 wt % based on the total weight of the binder 12. If the additive content exceeds 3 wt %, the effect of reduced resistance value variation will tend to be less notable. From the same viewpoint, the additive content is preferably at least 0.1 wt %.

The resin composing the binder 12 is not particularly restricted so long as it is a transparent resin that can anchor the conductive particles 11. As specific examples of resins there may be mentioned acrylic resins, epoxy resins, polystyrenes, polyurethanes, silicone resins, fluorine resins, and conductive polymers such as polyacetylene, polyphenylene, polyphenylenevinylene, polysilane, polyfluorene, polythiophene, polypyrrole and polyaniline. These resins may be used alone or in mixtures of two or more, and multiple resins may be physically or chemically bonded together. In the case of a curable resin such as an acrylic resin or epoxy resin, the binder 12 is formed in a cured state.

Acrylic resins are preferred among those mentioned above. Using an acrylic resin can further improve the optical transparency of the transparent electric conductor 10. Acrylic resins also have excellent resistance to acids and alkalis, as well as superior scratch resistance (surface hardness).

Acrylic resins are composed mainly of polymers obtained by polymerizing monomers and/or oligomers with (meth)acryloyl groups. Acrylic resins are typically formed by curing a resin composition containing a polymerization initiator and one or more types of polymerizable components selected from among (meth)acrylic monomers such as (meth)acrylic acid esters, and their oligomers or derivatives. The (meth)acrylic monomers and oligomers used have one or more (meth)acryloyl groups. The (meth)acrylic monomers and oligomers may also be used as mixtures of several types. In addition, acrylic polymers obtained by polymerizing polymethyl methacrylate or the like and having one or more (meth)acryloyl groups can also be used as polymerizable components.

The conductive particles 11 are composed of a transparent conductive oxide. As specific examples of transparent conductive oxides there may be mentioned indium oxide or indium oxide doped with one or more elements selected from the group consisting of tin, zinc, tellurium, silver, gallium, zirconium, hafnium and magnesium; tin oxide or tin oxide doped with one or more elements selected from the group consisting of antimony, zinc and fluorine; zinc oxide or zinc oxide doped with one or more elements selected from the group consisting of aluminum, gallium, indium, boron, fluorine and manganese; titanium oxide doped with one or more elements selected from the group consisting of vanadium, chromium, molybdenum, tungsten, niobium and tantalum; and complexes of calcium oxide and aluminum oxide. They most typically used type of conductive particles 11 are particles of indium oxide doped with tin, or indium tin oxide (ITO). The method for producing such transparent conductive oxides is not particularly restricted, and the production may be based on a dry method, wet method, spray method, laser ablation method, plasma method or the like.

The transparent conductive layer 15 may also contain other components in addition to those mentioned above. As examples of additional components there may be mentioned conductive compounds, organic or inorganic fillers, surface treatment agents, crosslinking agents, ultraviolet absorbers, radicals, scavengers, coloring agents, plasticizers and the like.

The thickness of the transparent conductive layer 15 is preferably 0.1-5 μm. If the thickness is less than 0.1 μm the resistance value will not be easily stabilized, while if the thickness is greater than 5 μm it may be difficult to obtain sufficient optical transparency.

The substrate 14 is not particularly restricted so long as it can support the transparent conductive layer 15, but a transparent polymer material is preferably used. Specifically, films of polyesters such as polyethylene terephthalate (PET) and polyethylene naphthalate (PEN), polyolefins such as polyethylene and polypropylene, and triacetylcellulose, polyethersulfone, polystyrene, polycarbonate, epoxy resins, acrylic resins, norbornane-based resins or polysiloxane-based resins may be used as the substrate 14. Alternatively, the substrate 14 may be a glass panel. The thickness of the substrate 14 is not particularly restricted so long as it is a thickness that can support the transparent conductive layer 15, and for example, the substrate 14 may be a film with a thickness of about 1 μm-500 μm or even a board or bulk body with a thickness of about 500 μm-100 mm.

Another layer may also be provided between the substrate 14 and transparent conductive layer 15. As examples of such other layers there may be mentioned layers having the functions of supports, adhesive layers, buffer layers, auxiliary conducting layers, anti-diffusion layers, ultraviolet ray-shielding layers, infrared ray-shielding layers, coloration layers, polarized light layers, light scattering layers, gas barrier layers and pressure-sensitive adhesive layers. Such layers may be used alone or in combinations of two or more. As a specific example, the transparent electric conductor 10 may have a laminated structure with the transparent conductive layer 15, an adhesive layer, a support (the same material as the substrate 14), a buffer layer and the substrate 14 laminated in that order, or a laminated structure with the transparent conductive layer 15, an auxiliary conducting layer, an ultraviolet ray-shielding layer and the substrate 14 laminated in that order. Also, such functional layers or a hard coat layer or the like, either alone or in combinations, may be formed on the side of the substrate 14 opposite the side on which the transparent conductive layer 15 is formed.

The method used to fabricate the transparent electric conductor 10 is not particularly restricted, and for example, it may be obtained by a production process comprising a step of forming an aggregate sheet by aggregation of the conductive particles 11, a step of impregnating the aggregate with a mixture containing the resin, additives and a solvent, a step of removing the solvent from the impregnated mixture, and if necessary a step of curing the resin. The transparent conductive layer may be formed directly on the substrate 14, or the transparent conductive layer may first be formed on a prescribed support and the substrate 14 laminated thereover.

The aggregate mentioned above is formed by a method including, for example, a step of coating a support with a dispersion containing the conductive particles 11 and a solvent, a step of removing the solvent from the coated dispersion, and a step of pressing the conductive particles remaining on the support to form an aggregate sheet in which the conductive particles are aggregated. The mixture containing the resin, additives and solvent fills the gaps within the formed aggregate.

The transparent electric conductor 10 will usually be used in its form with the substrate 14, but it can also be employed as a transparent electric conductor by releasing the substrate 14 for use as the transparent conductive layer 15 alone or together with a pressure-sensitive adhesive layer or adhesive layer. The transparent electric conductor 10 may be suitably used as a transparent electrode in touch panels and panel switches such as light transmitting switches. For example, the transparent conductive layer 15 may be used for either or both of the transparent electrodes of a touch panel comprising a pair of mutually opposing transparent electrodes and a dot spacer sandwiched between the transparent electrodes. A transparent electric conductor comprising the transparent conductive layer 15 may also be employed for purposes other than panel switches, such as noise-reduction parts, heating units, EL electrodes, LCDs, PDPs, antennas, phosphors, antistatic bodies, optical filters, thermal insulators and the like.

### EXAMPLES

The present invention will now be explained in greater detail by examples. However, the present invention is not limited to the examples described below.

Fabrication of Transparent Electric Conductor

A mixture of ITO powder (mean particle size: 30 nm) and ethyl alcohol (product of Kanto Kagaku Co., Ltd.) was subjected to dispersion treatment for 20 minutes using a bead mill (UAM-015 by Kotobuki Industries Co., Ltd.) with 0.5 mm-diameter zirconia beads, to obtain an ITO dispersion.

The ITO dispersion was coated onto a polyethylene terephthalate (PET) film (support film by Teijin, Ltd., thickness: 100 μm) using a bar coater. The solvent was removed from the dispersion on the PET film by heating, and then a separate PET film (protective film by Teijin, Ltd., thickness: 25 μm) was placed over the coated surface and pressed with a press roller. This produced an aggregate sheet comprising aggregated ITO powder.

After releasing the protective film from the aggregate sheet, it was impregnated with a solution comprising a mixture of the following components (photosensitive resin solution).
Acrylic monomer and acrylic oligomer (Shin-Nakamura Chemical Co., Ltd.)
Acrylic resin (Negami Chemical Industrial Co., Ltd.)
Methyl ethyl ketone (Kanto Kagaku Co., Ltd.)
Vinyltrimethoxysilane (Shin-Etsu Chemical Co., Ltd.)
Photopolymerization initiator (Ciba Specialty Chemicals Co., Ltd.)
One from among additives I-VI

Additives I and II are peroxides represented by the following formulas (1a) and (1b), respectively, and their 10 hour half-lives are 116° C. for additive I and 104° C. for additive II. Additives III and IV are azo compounds represented by the following formulas (2a) and (2b), respectively, and their 10 hour half-lives are 110° C. for additive III and 104° C. for additive IV. Additives V and VI are phenol compounds represented by the following formulas (3a) and (3b), respectively.

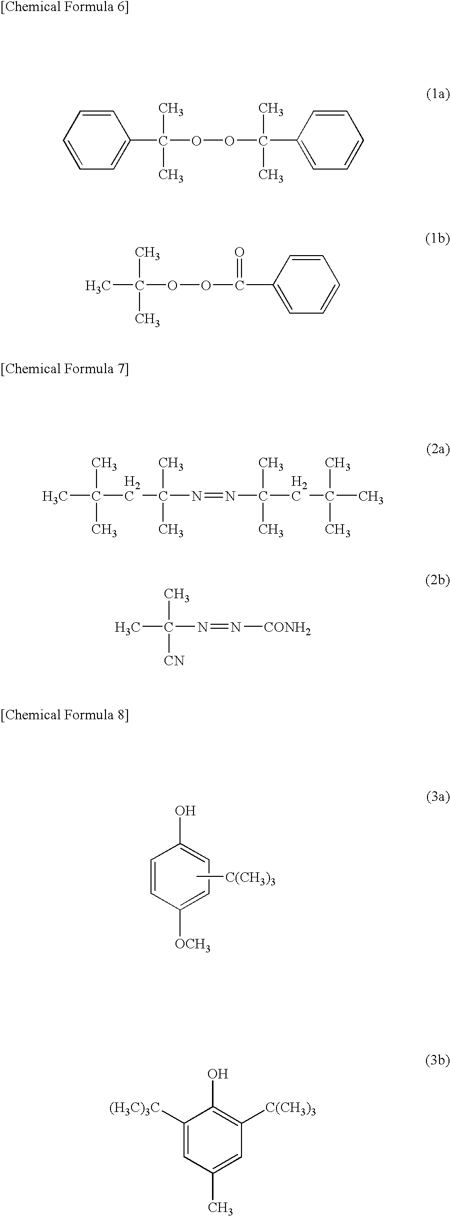

The methyl ethyl ketone was removed from the impregnated photosensitive resin solution by heating, and a PET film (substrate by Teijin, Ltd., thickness: 188 μm) was attached thereto. This was exposed to light of 420 nm to a cumulative lux of 2000 mJ/cm² using a metal halide lamp as the light source to cure the photosensitive resin, thus forming a transparent conductive layer containing a cured acrylic resin to obtain a transparent electric conductor.

Evaluation of Resistance Variation

After releasing the support film from the transparent electric conductor, a 50 mm square test piece was cut out from the transparent electric conductor and electrodes were formed with silver conductive paste at positions 5 mm from any two opposite edges of the exposed transparent conductive layer surface. A Digital Multimeter (Sanwa Electrical Instrument Co., Ltd.) was connected between the electrodes, and the resistance value (initial resistance value) between the electrodes was measured. The same test piece was then set in a thermohygrostat (Espec Corp.) and allowed to stand under the load conditions listed in Table 1, after which the resistance value between the electrodes was again measured (resistance value after load). The rate of variation in the resistance value was calculated by the following formula: Variation rate=resistance value after load/initial resistance value.

Test pieces No. 1-No. 13 having different contents for additives I-VI were used for load testing by the procedure described above under the load conditions listed in Table 1, and the rate of variation in the resistance value before and after the test was determined. The results are shown in Table 1. In Table 1, the contents of additives I-VI are given as ratios (wt %) with respect to the weight of the binder, and they were determined as follows. That is, a cut piece obtained by cutting a 10 mm square from the test piece prior to the load test was treated for 24 hours in a refluxer together with 50 mL of dichloromethane for extraction of the additives I-VI, and the amount of elution of the additives I-VI in the extract was determined. To determine the amount of elution, a calibration curve was drawn based on the measured values from high performance liquid chromatography (HPLC), and calculation was performed by the prescribed formula. The contents (wt %) of the additives I-VI based on the binder weight were determined from the elution amounts. The binder weight was determined by calculating the binder content for the test piece by thermogravimetric analysis (TGA).

TABLE 1

| | | | Load | | Resistance value (Ω) | | |
|---|---|---|---|---|---|---|---|
| | Additive | | conditions | | Initial | Resistance | Var- |
| | | Content | Temp. | Time | resistance | value after | iation |
| No. | Type | (wt %) | (° C.) | (hr) | value | load | rate |
| 1 | I | 0.1 | 100 | 10 | 605 | 911 | 1.51 |
| 2 | I | 1.0 | 100 | 10 | 596 | 870 | 1.46 |
| 3 | I | 2.0 | 100 | 10 | 581 | 941 | 1.62 |
| 4 | I | 3.0 | 100 | 10 | 589 | 931 | 1.58 |
| 5 | I | 1.0 | 140 | 1 | 611 | 935 | 1.53 |
| 6 | II | 1.0 | 100 | 10 | 591 | 881 | 1.49 |
| 7 | III | 1.0 | 100 | 10 | 620 | 961 | 1.55 |
| 8 | IV | 1.0 | 100 | 10 | 602 | 903 | 1.50 |
| 9 | V | 1.0 | 100 | 10 | 609 | 925 | 1.52 |
| 10 | VI | 1.0 | 100 | 10 | 618 | 946 | 1.53 |
| 11 | I | 3.5 | 100 | 10 | 593 | 1000 | 1.69 |
| 12 | I | 1.0 | 150 | 1 | 594 | 1348 | 2.27 |
| 13 | — | 0 | 100 | 10 | 584 | 1470 | 2.52 |

As seen by the results in Table 1, including the additives I-VI inhibited variation in the resistance value in a high-temperature environment. The resistance value variation rate was particularly low for test piece Nos. 1-10 in which the contents of additives I-VI were no greater than 3 wt %. Among the test pieces containing additive I at 1.0 wt %, standing at a high temperature of 150° C., as with No. 12, resulted in a higher resistance value variation rate compared to 100° C. (No. 2), but still maintained a lower variation rate than the variation rate at 100° C. as with No. 13 which contained no additives. Also, No. 11 had a lower variation rate than No. 12, but the test piece exhibited yellowing.

What is claimed is:

1. A transparent electric conductor comprising a transparent conductive layer containing conductive particles and a binder,
wherein the binder includes at least one additive selected from among compounds represented by the following general formula (1), (2) or (3). 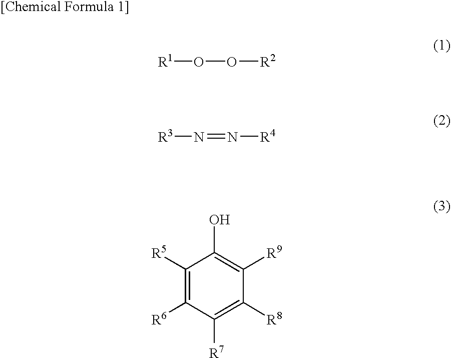
[In formula (1), R¹ and R² each independently represent hydrogen or a monovalent organic group, in formula (2), R³ and R⁴ each independently represent a monovalent organic group, and in formula (3), R⁵, R⁶, R⁷, R⁸ and R⁹ each independently represent hydrogen, methyl, butyl, hydroxyl or methoxy.]

2. A transparent electric conductor according to claim 1, wherein the additive content is no greater than 3 wt % based on the weight of the binder.

3. A transparent electric conductor according to claim 1, wherein the decomposition temperature of the additive is 60° C. or higher

4. A transparent electric conductor according to claim 2, wherein the decomposition temperature of the additive is 60° C. or higher.
